(19) United States
(12) Patent Application Publication
(10) Pub. No.: US 2022/0399788 A1
(43) Pub. Date: Dec. 15, 2022

(54) PROCESS FOR MAKING A CONTINUOUS WINDING FOR A STATOR OF AN ELECTRIC MACHINE AND WINDING MADE WITH SUCH PROCESS

(71) Applicant: MAVEL EDT S.P.A., PONT SAINT MARTIN (AO) (IT)

(72) Inventors: Luca FAVRE, Valpelline (AO) (IT); Davide BETTONI, Settimo Vittone (TO) (IT)

(21) Appl. No.: 17/776,298

(22) PCT Filed: Nov. 12, 2019
(86) PCT No.: PCT/IT2019/000101

§ 371 Date: May 12, 2022

(51) Int. Cl. H02K 15/00; H02K 3/487

(52) U.S. Cl. CPC H02K 15/0018; H02K 3/487

(57) ABSTRACT

A process is described, for making a continuous winding for a stator of an electric machine comprising the following steps: bending on a plane of a strip to make a strap in a single piece, which comprises first sectors to be inserted inside closed slots of a stator and connected by second bending sectors which remain outside the slots; providing a first, internal stator part comprising a plurality of longitudinal teeth, spaced by a space which makes the lower part of the slots; making the winding on the first stator part, by placing the first sectors of strap in the spaces included between the teeth; and connecting the two free ends of every strap; a continuous winding made with such process is further described.

The present invention refers to a process for making a continuous winding for a stator of an electric machine and to a winding made with such process.

In particular, the invention refers to a process for making a continuous winding, using a metal slat, for a stator of a rotary electric machine with closed slots.

Known electric machines comprise a fixed part, the stator, and a moving part, the rotor, arranged coaxially one inside the other. Typically, the rotor comprises a pack of sheets fastened onto a rotation shaft, and is inserted inside the stator, which comprises an electric winding adapted to generate a magnetic field which rotates the rotor.

The stator generally is of an annular shape and comprises a plurality of radial slots, inside which the electric winding is made.

For making the electric windings of the stator, it is known to use copper bands, which are bent in their central part to form straps shaped as a hairpin, called “hairpins”, to be inserted in the slots of the stator.

The bending shape and angle of the bands change when the geometry of the stator and of the slots changes, and when the winding scheme changes.

These straps are inserted into the slots of the stator from the same side, with the two terminals of every strap inserted in different slots, according to a certain scheme, to obtain the exact number of coils necessary to compose the desired winding; the ends of the straps which project from the slots are bent with a twisting process, to prevent them from going out, and are then mutually welded, after having removed the insulating material from the welding area, in order to create a correct connection between the different copper straps to form the stator winding.

This known process ends with insulating the welding areas through resins; finally, the stator and the straps are made integral by immersing their ends into a resin.

This known process of making the windings through the use of hairpins has a series of problems, caused by the several welding spots being present in the winding, which cause an increase of the resistance to the passage of current and which require the presence of several quality controls for the welding, by the process complexity, with problems linked for example to the need of insulating the winding with resins, to the process complexity and the limits to the length which can be used for bands, due to the difficulty of inserting it into the stator slots, in particular in the closed slots.

Object of the present invention is solving these problems through a process for making a continuous winding for a stator of an electric machine and a winding made with such process, which allow a drastic reduction of the number of welding being present in the winding, a lower insulation through resins, a reduction of the resistance to the passage of current in the winding, the removal of the twisting process, a reduction of quality controls within the process, make it possible to obtain windings on stators with a greater active lengths, with lower costs, better filling of the slots by the winding and in general a better efficiency of the electric machine being made.

The above and other objects and advantages of the invention, as will result from the following description, are obtained with a process for making a continuous winding for a stator of an electric machine and a winding made with such process as claimed in the independent claims.

Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention, as appears from the enclosed claims.

The present invention will be better described by some preferred embodiments thereof, provided as a non-limiting example, with reference to the enclosed drawings, in which:

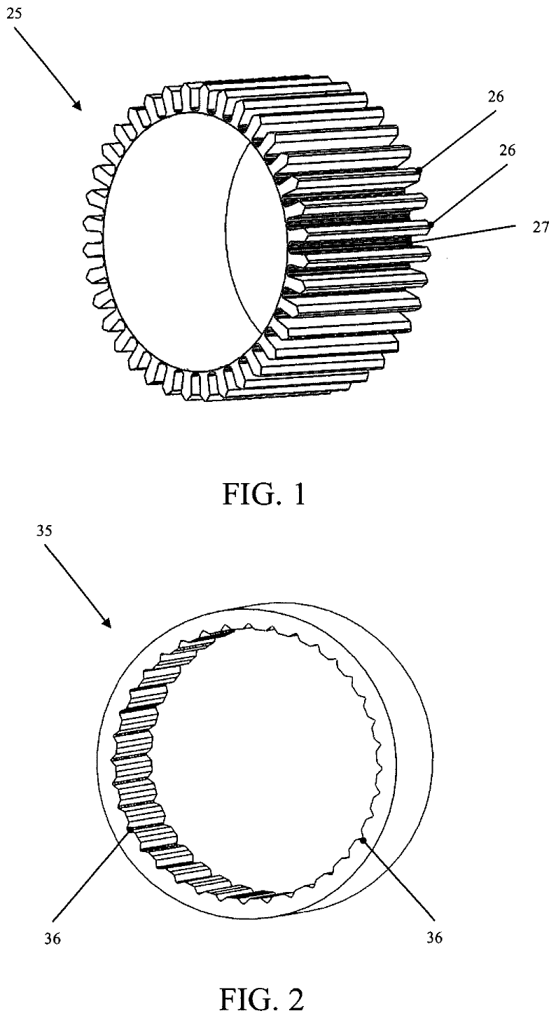

FIG. 1 shows a perspective view of an internal part of a stator of an electric machine used in the process of the invention;

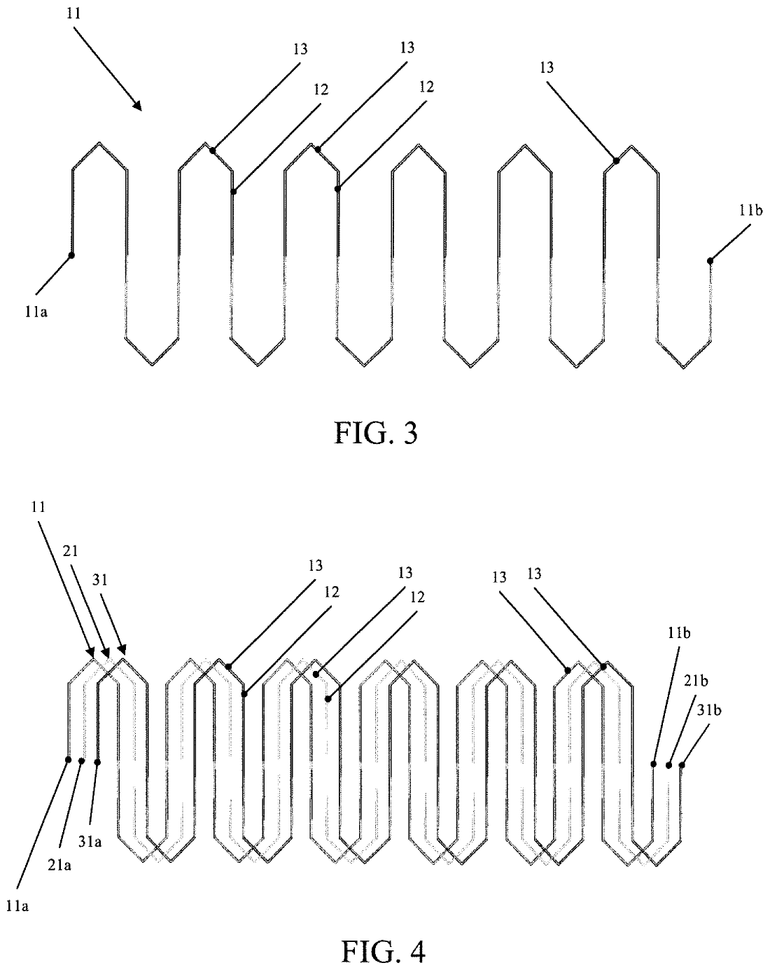

FIG. 2 shows a perspective view of an external part of a stator of an electric machine used in the process of the invention;

FIG. 3 shows a view of a continuous winding for a stator of an electric machine of the invention;

FIG. 4 shows a view of a plurality of continuous windings for a stator of an electric machine of the invention;

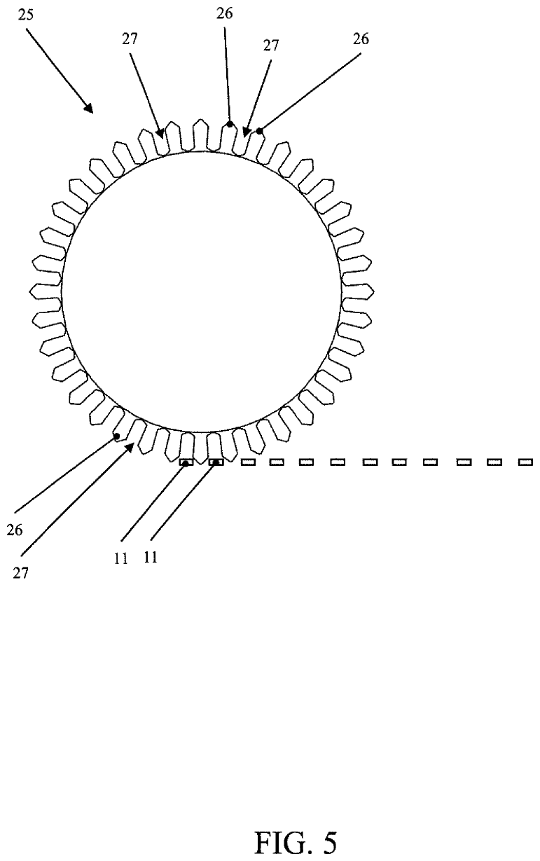

FIG. 5 shows a schematic view of an internal part of a stator and of a continuous winding of the invention;

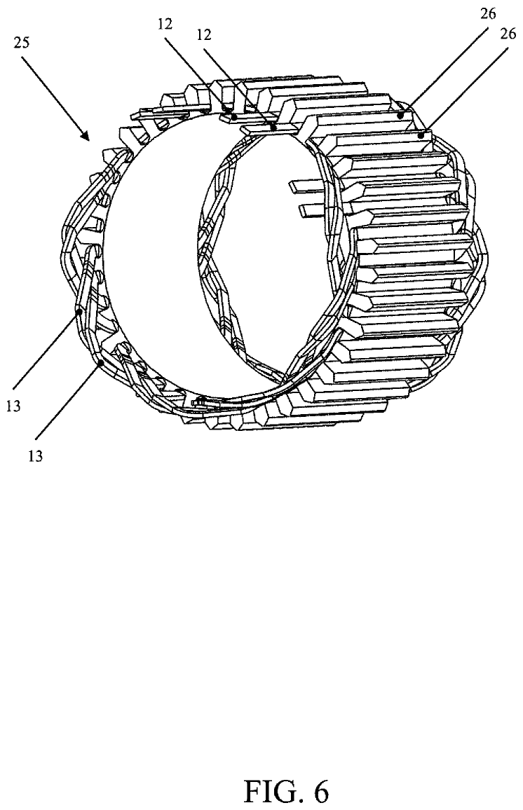

FIG. 6 shows a perspective view of an internal part of a stator of an electric machine with a continuous winding of the invention; and

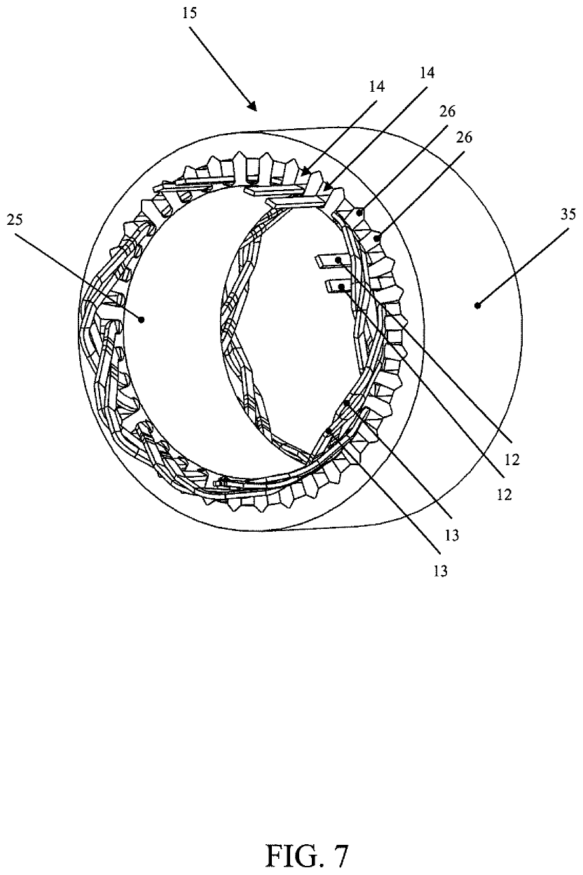

FIG. 7 shows a perspective view of a stator of an electric machine with a continuous winding of the invention.

With reference to the Figures, the process for making a continuous winding for a stator of an electric machine of the invention comprises the following steps:
a step of bending on a plane at least one strip, for example with section having side whose sizes are included between 1 mm and 7 mm, and strip length between 400 mm and 1000 mm, to make at least one strap 11, 21, 31 in a single piece, typically a strap 11, 21, 31 for every electric phase, for example three straps 11, 21, 31 in case of a three-phase current, each strap 11, 21, 31 comprising a plurality of first sectors 12, preferably equal in shape and sizes and mutually parallel, preferably substantially rectilinear, configured to be inserted inside closed slots 14 of a stator 15 and mutually connected by a plurality of second bending sectors 13, in a preferred way mutually equal regarding shape and sizes, and configured to remain outside the closed slots 14 of the stator 15; in particular, the first sectors 12 and the second sectors 13 are mutually alternate, every first sector 12 being connected at at least one end thereof to a second sector 13, preferably being the two ends of each first sector 12 connected to two different second sectors 13. In a preferred way, the section of each strap 11, 21, 31 has the shape of the section of the closed slots 14 of the stator 15 so that, once inserted into said closed slots 14, the strap 11, 21, 31 completely fills them;
a step of providing the stator 15, said stator comprising a first internal stator part 25 comprising a plurality of longitudinal teeth 26, spaced by a space 27 configured to make the lower part of the closed slots 14 of the stator, and a second external annular part 35 of the stator, comprising a plurality of seats 36 complementary to the teeth 26 of the first stator part 25 and configured to be meshed with the first stator part 25 in order to form the closed slots 14 and the stator 15; in particular, said seats 36 obtained in the second stator part 35 are configured to mesh with the teeth 26 of the first stator part 25 in order to form the closed stator slots 14, through a mutual sliding movement of the first, internal stator part 25 and of the second external part 35, for example along the direction of the axis of the stator 15, making a coupling, for example of the dovetail type or other known coupling type;
a step of making the winding on the first, internal stator part 25 of said at least one strap 11, 21, 31, in a preferred way of said three mutually alternated straps 11, 21, 31, placing the first sectors 12 of strap 11, 21, 31 in the spaces 27 included between the teeth 26; in particular, the strap 11, 21, 31 is wound on the first stator part 25 in order to mesh it between the teeth 26 of the first, internal stator part 25, similarly to how a chain is meshed onto the teeth of a gear, through a relative rotation of the first, internal stator part 25 with respect to the strap 11, 21, 31, as shown in FIG. 5; in particular, the number of rotations is equal to the number of slot coils;
a step of connecting, preferably through welding, the two free ends 11a and 11b, 21a and 21b, 31a and 31b of every strap 11, 21, 31;
a step of insulating the welding spots in a known way, for example through epoxy deposited through dripping;
a step of checking the absence of connection errors, welding problems or of short-circuit problems among the different electric phases.

In order to complete the assembling of the stator 15, after the step of insulating the welding, the following steps are provided:
a step of positioning the second, external stator part 35 on the first, internal stator part so that the seats 36 obtained in the second, external stator part 35, by being meshed with the teeth 26 of the first, external stator part 25, form the closed slots 14 of the stator 15;
a step of checking the absence of connection errors, welding problems or of short-circuit problems among the different electric phases;
a step of resin coating, through immersion of the ends of the straps 11, 21, 31 projecting from the closed slots 14 and of the heads of the stator 15 into a resin configured to make the stator 15 and the straps 11, 21, 31 mutually integral, avoiding future damages due to vibrations.

The continuous winding for a stator of an electric machine of the invention will be described below, said stator comprising a first, internal stator part 25 which comprises a plurality of longitudinal teeth 26 spaced by a space 27, said continuous winding comprising at least one strap 11, 21, 31 which comprises a plurality of first sectors 12 mutually connected by a plurality of second sectors 13 alternate thereto, said at least one strap 11, 21, 31 being configured to be wound on the first, internal stator part 25, placing the first sectors 12 of the straps 11, 21, 31 into the spaces 27 included between the teeth 26. In a preferred way, the first sectors 12 are mutually parallel, being every first sector 12 connected at at least one end thereof to a second sector 13, and the winding comprises three, mutually alternated straps 11, 21, 31.

Advantageously, the process for making a continuous winding for a stator of an electric machine of the invention enables a drastic reduction of the number of welding spots present in the winding, a lower insulation through resins, a reduction of the resistance to the passage of current in the winding, the removal of the twisting process, a reduction of quality controls inside the process, and makes it possible to obtain windings on stators with greater active length, with lower costs, better filling of the slots by the winding, and in general a better efficiency of the electric machine being made.

1. A process for making a continuous winding for a stator of an electric machine comprising the following steps:
a step of bending on a plane at least one strip to make at least one strap in a single piece, said strap comprising a plurality of first sectors configured to be inserted inside closed slots of a stator and mutually connected by a plurality of second bending sectors configured to remain outside the closed slots of the stator;
a step of providing a first, internal stator part comprising a plurality of longitudinal teeth, spaced by a space configured to make the lower part of the closed slots of the stator;
a step of making the winding on the first, internal stator part of said at least one strap, placing the first sectors of the straps into the spaces included between the teeth;
a step of connecting the two free ends of every strap.

2. The process for making a continuous winding for a stator of an electric machine according to claim 1, characterized in that it further comprises the following steps:
a step of insulating the welding spots;
a step of checking an absence of connection errors, welding problems or of short-circuit problems.

3. The process for making a continuous winding for a stator of an electric machine according to claim 1, characterized in that the first sectors are mutually parallel and alternated with the second sectors, every first sector being connected in at least one end thereof to a second sector.

4. The process for making a continuous winding for a stator of an electric machine according to claim 1, characterized in that the two ends of each first sector are connected to two different second sectors.

5. The process for making a continuous winding for a stator of an electric machine according to claim 1, characterized in that three straps are made and wound mutually alternated on the first, internal stator part.

6. The process for making a continuous winding for a stator of an electric machine according to claim 1, characterized in that it comprises a strap for every electric phase.

7. The process for making a continuous winding for a stator of an electric machine according to claim 1, characterized in that, in the step of making the winding, the strap is wound on the first stator part, in the spaces included between the teeth, through a relative rotation of the first, internal stator part with respect to the strap.

8. The process for making a continuous winding for a stator of an electric machine according to claim 1, characterized in that the section of each strap has the shape of the section of the closed slots of the stator.

9. A continuous winding for a stator of an electric machine, made with a process according to claim 1, characterized in that it comprises at least one strap comprising a plurality of first sectors mutually connected by a plurality of second sectors alternated thereto, said at least one strap being configured for be wound on the first, internal stator part by placing the first sectors in the spaces included between the teeth.

10. The continuous winding for a stator of an electric machine according to claim 9, characterized in that the first sectors are mutually parallel, being every first sector connected in at least one end thereof to a second sector, and in that the winding comprises three mutually alternated straps.
